(19) United States
(12) Patent Application Publication
(10) Pub. No.: US 2003/0109383 A1
(43) Pub. Date: Jun. 12, 2003

(54) Ceramic catalyst body

(76) Inventors: Kazuhiko Koike, Okazaki-city (JP); Tosiharu Kondo, Toyoake-city (JP); Tomohiko Nakanishi, Kariya-city (JP); Miho Ito, Hoi-gun (JP); Jun Hasegawa, Hekinan-city (JP)

Correspondence Address: Nixon & Vanderhye P.C., 8th Floor, 1100 North Glebe Road, Arlington, VA, 22201-4714, US

(21) Appl. No.: 10/310,038

(22) Filed: Dec. 5, 2002

(30) Foreign Application Priority Data
Dec. 6, 2001 (JP) 2001-373064
Oct. 4, 2002 (JP) 2002-292133

(51) Int. Cl. B01J 23/02

(52) U.S. Cl. 502/439; 502/254; 502/304

(57) ABSTRACT

In a catalyst body using a direct support, this invention provides a ceramic catalyst body capable of adjusting catalyst performance in accordance with intended objects such as prevention of deactivation of a main catalyst component when an sub catalyst component is used, or improvement of initial purification performance. When both main catalyst component and sub catalyst component are supported on a ceramic support capable of directly supporting the catalyst components, the invention first supports a catalyst metal as a main catalyst such as Pt, for example, and then supports the sub catalyst such as CeO₂ on the main catalyst. The main catalyst is thus prevented from being involved in the grain growth of the sub catalyst, and becomes a catalyst body that does not easily undergo thermal deactivation. The ceramic support uses cordierite, a part of the constituent elements of which are replaced, so that the replacing elements so introduced can directly support the catalyst components. The bonding strength of the catalyst components can thus be improved and the thermal durability of the catalyst can also be improved.

### BACKGROUND OF THE INVENTION

1. Field of the Invention

This invention relates to a ceramic catalyst body applied to an exhaust gas purification catalyst of an automobile engine.

2. Description of the Related Art

Various catalysts have been proposed in the past to purify detrimental substances emitted from automobile engines. The exhaust gas purification catalyst generally uses a cordierite honeycomb structure having high heat and-impact resistance as a support. After a coating layer of a material having a high specific surface area such as γ-alumina is formed on a surface of the support, a catalyst precious metal and an sub catalyst component are supported. The reason why the coating layer is formed is because cordierite has a small specific surface area. The surface area of the support is increased by use of γ-alumina, or the like, and a necessary amount of the catalyst components is supported.

However, the formation of the coating layer invites an increase in a thermal capacity of the support and is not advantageous for early activation of the catalyst. In addition, an open area becomes small and a pressure loss increases. Because γ-alumina itself has low heat resistance, there remains the problem that the catalyst particles aggregate and purification performance greatly drops. Therefore, methods for increasing the specific surface area of cordierite itself have been examined in recent years. Japanese Examined Patent Publication (Kokoku) No. 5-50338 describes a method that eliminates the coating layer by conducting first an acid treatment and then a heat-treatment to cause elution of a part of the cordierite constituent components and to support the catalyst components in the resulting voids. However, this method is not free from the problem that a crystal lattice of cordierite is destroyed through the acid treatment and the heat-treatment, and the strength drops. Therefore, this method is not yet practical.

In contrast, the inventors of this invention have previously proposed a ceramic support capable of directly supporting a necessary amount of catalyst components without forming the coating layer to improve the specific surface area while retaining the strength (Japanese Unexamined Patent Publication (Kokai) No. 2001-310128). In this direct ceramic support, at least one kind of constituent elements of a substrate ceramic is replaced by an element having different valence so that a large number of fine pores consisting of lattice defect inside a crystal lattice are formed on the surface of the substrate ceramic. As these fine pores are extremely small, the specific surface area hardly changes and the fine pores can directly support a necessary amount of the catalyst components without inviting the problem of the drop of the strength that has been observed in the catalyst bodies of the prior art.

Besides the catalyst precious metal such as Pt as the main catalyst, various sub catalysts are generally supported depending on the application in the exhaust gas purification catalyst. It has been clarified, however, that when these catalyst components are supported on the ceramic support capable of directly supporting them without using the coating layer, the catalyst precious metal aggregates in the course of the use of the catalyst for a long time depending on the mode of supporting the catalysts to thereby invite a difference in catalyst performance such as initial performance and the degree of deactivation. When the sub catalyst components are used, thermal deactivation of the precious metal catalyst becomes more likely than when they are not used.

### SUMMARY OF THE INVENTION

It is therefore an object of the invention to provide a high-performance ceramic catalyst body that can provide a desired purification performance by making the most of characteristics of both main catalyst components and sub catalyst components to be supported, can suppress thermal deactivation of the catalyst components and can effectively exhibit a desired capability depending on the application in a ceramic catalyst body supporting both a main catalyst component and sub catalyst components on a direct support ceramic support.

According to a first aspect of the invention, there is provided a ceramic catalyst body using a ceramic support capable of directly supporting catalyst components on a surface of a substrate ceramic, and prepared by directly supporting a main catalyst component and an sub catalyst component on the ceramic support, wherein either one of the main catalyst component and the sub catalyst component is first supported on the ceramic support and the other is then supported.

It has been clarified that when the main catalyst component and the sub catalyst component are directly supported on the direct support ceramic support, the supporting sequence of the main catalyst component and the sub catalyst component on the surface of the substrate ceramic greatly affects catalyst performance. In the catalyst bodies of the prior art having a porous coating layer of γ-alumina or the like, the exhaust gas enters voids of γ-alumina and comes into contact with the catalyst components supported on its surface. In contrast, as the catalyst components are directly supported on the surface of the substrate ceramic in the direct support ceramic support, the influences of the catalyst components that exist on the surface layer, and are more likely to come into contact with the exhaust gas, become great. Unlike the construction of the prior art in which γ-alumina itself entraps the catalyst components and undergoes thermal deactivation in connection with thermal deactivation, the influences of bondability between the substrate ceramic and the catalyst components become great. Therefore, when the main catalyst component is arranged in the lower layer to strengthen bonding with the substrate ceramic, the effect of suppressing deactivation can be improved. Alternatively, when the main catalyst component is arranged in the higher layer, the main catalyst component is allowed to effectively exhibit its performance and purification performance can be improved. In this way, it is possible to accomplish an excellent ceramic catalyst body that effectively exhibits catalyst performance in accordance with required performance, and has high strength, low thermal capacity and low pressure loss.

In the invention described above, at least 75% of the catalyst components directly supported on the ceramic support is preferably the main catalyst component.

The reason why thermal deactivation of the main catalyst component is likely to occur when the main catalyst component and the sub catalyst component are directly supported on the direct support ceramic support is presumably because the grains of the sub catalyst component have a relatively low bonding strength aggregate and grow due to heat while entrapping the main catalyst component. Therefore, to prevent thermal deactivation of the main catalyst component, the main catalyst component is first supported and sintered and the sub catalyst component is then supported and sintered. According to this sequence, after the main catalyst component is firmly bonded to the substrate ceramic of the direct support ceramic support, the sub catalyst component is supported so that even when the sub catalyst component moves due to heat, the firmly bonded main catalyst component is not easily entrapped. Particularly when at least 75% of the catalyst components directly supported is the main catalyst component, it becomes possible to sufficiently secure firmly bonded the main catalyst component, to suppress its grain growth to a low level and to effectively suppress the drop of purification performance due to heat. The ceramic catalyst body described above can be appropriately used as a start catalyst fitted to an automobile having a gasoline engine fitted therein. In the invention described above, at least 75% of the catalyst components directly supported on the ceramic support is preferably the sub catalyst component. When the construction in which the sub catalyst component is first supported and sintered and the main catalyst component is then supported and sintered is employed, the main catalyst component is positioned in the upper layer of the catalyst layers formed on the surface of the ceramic support, and the contact probability with the exhaust gas becomes greater. Particularly when at least 75% of the catalyst components directly supported is the sub catalyst, the contact probability between the main catalyst component and the exhaust gas can be sufficiently improved, and the effect of improving purification performance can be expected.

The ceramic catalyst body is appropriately used as an under-floor catalyst fitted to an automobile having a gasoline engine mounted thereto or as an oxidation catalyst fitted to an automobile having a Diesel engine mounted thereto.

A precious metal catalyst is appropriately used as the main catalyst component. As this time, when a mean particle diameter of the main catalyst component is not greater than 100 nm, the catalyst components can be highly dispersed at the same support amount and purification performance can be improved. The mean particle diameter of the sub catalyst component is preferably not greater than 100 nm.

The ceramic support described above ceramic has a large number of fine pores capable of directly supporting a catalyst on the surface of the substrate ceramic, and the fine pores can directly support the catalyst components. Consequently, it is possible to obtain a catalyst body capable of directly supporting the catalyst components on the ceramic support without using the coating layer.

The fine pore is at least one kind of a defect inside a ceramic crystal lattice, a fine crack on a ceramic surface and a defect of elements constituting the ceramic. When a width of the fine crack is not greater than 100 nm, the support strength can be preferably secured.

To support the catalyst components, the fine pore preferably has a diameter or width not greater than 1,000 times the diameter of a catalyst ion to be supported. When the number of the fine pores is at least 1×10¹¹/L at this time, the same amount of the catalyst components can be supported as in the catalyst bodies according to the prior art.

It is possible to use, as the ceramic support described above, a ceramic support wherein one or more kinds of elements constituting the substrate ceramic of the ceramic support are replaced by elements other than the constituent elements, and the catalyst component can be directly supported by the replacing elements. Preferably, the catalyst component is supported on the replacing elements through chemical bonds. When the constituent elements are chemically bonded, retainability can be improved. Because the catalyst components are uniformly dispersed in the support and do not easily undergo aggregation, deactivation of the catalyst body in the course of use can be decreased. One or more kinds of elements having a d or f orbit in an electron orbit thereof can be used as the replacing elements described above. The elements having the d or f orbit in the electron orbit thereof are preferred because they easily combine with the catalyst components.

The ceramic support described above preferably contains cordierite as a component thereof. When cordierite is used, thermal impact resistance can be improved.

### BRIEF DESCRIPTION OF THE DRAWINGS

FIG. 1 is a schematic view showing a construction of a ceramic catalyst body according to Embodiment 1 of the invention;

FIG. 2 is a schematic view showing a construction of a ceramic catalyst body according to Embodiment 2 of the invention;

FIG. 3(a) is a schematic view showing a supporting state of a main catalyst and an sub catalyst in a catalyst body of the invention; and

FIG. 3(b) is a schematic view showing a state supporting state of a main catalyst and an sub catalyst in a catalyst body according to the prior art.

### DESCRIPTION OF THE PREFERRED EMBODIMENTS

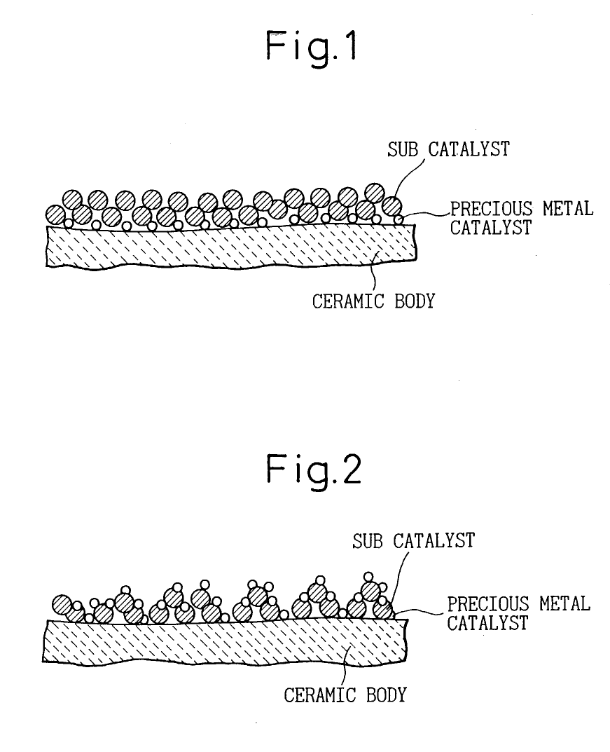

Hereinafter, the invention will be explained in detail with reference to the accompanying drawings. FIG. 1 shows a schematic construction of a ceramic catalyst body according to the invention. A ceramic support supports a precious metal catalyst as a main catalyst and an sub catalyst. The ceramic support is a support that can directly support the catalyst components on a surface of a substrate ceramic. The ceramic support directly supports the particles of each of the precious metal catalyst and the sub catalyst without using a coating layer. The support form of both precious metal catalyst and the sub catalyst constitutes the characterizing part of the invention and will be described later in detail. As the ceramic catalyst body according to the invention does not require the coating layer, the ceramic catalyst body hardly invites deactivation of the catalyst components and can reduce a heat capacity and a pressure loss. This ceramic catalyst body can be therefore used suitably for an exhaust gas purification catalyst for automobiles.

The substrate ceramic of the ceramic support is suitably those which consist of cordierite the theoretical composition of which is expressed by 2MgO.2Al₂O₃.5SiO₂ as a main component. When the ceramic support is used for the automobile catalyst, the substrate ceramic is generally shaped into a honeycomb structure having a large number of flow passages in a gas flowing direction and is then sintered to give the ceramic support. Having high heat resistance, cordierite is suitable for the automobile catalyst used under a high temperature condition. However, the substrate ceramic can use ceramics other than cordierite, such as alumina, spinel, aluminum titanate, silicon carbide, mullite, silica-alumina, zeolite, zirconia, silicon nitride and zirconium phosphate. The support shape is not particularly limited to the honeycomb shape but may be other shapes such as pellet, powder, foam, hollow fiber, fiber, and so forth.

The first feature of the invention is that it uses a ceramic support having a large number of fine pores capable of directly supporting the catalyst components on a substrate ceramic surface, or a ceramic support having a large number of replacing elements capable of directly supporting the catalyst components. The fine pores concretely consist of at least one kind of defect (oxygen defect or lattice defect) in the ceramic crystal lattice, fine cracks on the ceramic surface and defects of the elements constituting the ceramic. At least one kind of these defects may well be formed in the ceramic support, and a plurality of kinds may be formed in combination. The element capable of directly supporting the catalyst components is, concretely, the element that is introduced by replacing one or more kind of element constituting the substrate ceramic by an element other than the constituent element. Because the ceramic support directly supports the catalyst components in such fine pores or replacing elements, it can support the catalyst components without forming a coating layer having a high specific surface area such as γ-alumina and while keeping the strength.

First, the ceramic support having a large number of fine pores capable of directly forming the catalyst components on the surface of the substrate ceramic will be explained. The diameter of the catalyst component ion supported hereby is generally about 0.1 nm. Therefore, when the fine pores formed in the cordierite surface have a diameter or width of at least 0.1 nm, they can support the catalyst component ion. To secure the strength of the ceramic, the diameter or width of the fine pores is not greater than 1,000 times (100 nm) the diameter of the catalyst component ion and is preferably as small as possible. The diameter or width is preferably 1 to 1,000 times (0.1 to 100 nm). To hold the catalyst component ion, the depth of the fine pores is preferably at least ½times (0.05 nm) the diameter. To support an equivalent amount of the catalyst component (1.5 g/L) to that of the prior art catalysts, the number of fine pores is at least 1×10¹¹/L, preferably at least 1×10¹⁶/L and more preferably at least 1×10¹⁷/L.

Of the defects forming the fine pores in the ceramic surface, the defects of the crystal lattice include oxygen defects and lattice defects (metal vacancy lattice points and lattice strains). The oxygen defects develop due to deficiency of oxygen constituting the ceramic crystal lattice. The fine pores formed due to fall-off of oxygen can support the catalyst components. The lattice defects develop when oxygen is entrapped in an amount greater than the necessary amount for forming the ceramic crystal lattice. The fine pores formed by the strain of the crystal lattice and the metal vacancy lattice point can support the catalyst components.

More concretely, when the cordierite honeycomb structure contains at least 4×10⁻⁶%, preferably at least 4×10⁻⁵%, of a cordierite crystal having in a unit crystal lattice at least one kind of the oxygen defect and the lattice defect, or at least 4×10⁻⁸, preferably at least 4×10⁻⁷, of at least one kind of the oxygen defect and the lattice defect in the unit crystal lattice of cordierite, the number of fine pores of the ceramic support exceeds the predetermined number described above. Next, the detail of the fine pores and a formation method will be explained.

To create the oxygen defect in the crystal lattice, the following three methods can be employed in a process for shaping a cordierite material containing an Si source, an Al source and an Mg source, including the steps of degreasing and then sintering the material as described in Japanese Patent Application No. 2000-104994: (1) a sintering atmosphere is set to a reduced pressure or reducing atmosphere, (2) a compound not containing oxygen is used as at least a part of the material, and sintering is conducted in a low oxygen concentration atmosphere so as to render oxygen in the sintering atmosphere or in the starting material deficient, and (3) at least one kind of the constituent elements of the ceramic other than oxygen is replaced by use of an element having a smaller valence than that of the constituent element. In the case of cordierite, the constituent elements have positive charge, that is, Si (4+), Al (3+) and Mg (2+). Therefore, when these elements are replaced by elements having smaller valence, the positive charge corresponding to the difference of valence of the replaced elements and to the replacing amount becomes deficient, and oxygen O (2−) having the negative charge is emitted to keep electrical neutrality as the crystal lattice, thereby creating the oxygen defects.

The crystal defects can be created by (4) replacing a part of the ceramic constituent elements other than oxygen by use of an element or elements having greater valence than that of the constituent elements. When a part of Si, Al and Mg as the constituent elements of cordierite is replaced by an element having greater valence than that of the constituent element, the positive charge corresponding to the difference of valence of the replaced element and to the replacing amount becomes excessive, and a necessary amount of O (2−) having the negative charge is entrapped to keep electrical neutrality as the crystal lattice. The cordierite crystal lattice cannot be aligned in regular order as oxygen so entrapped functions as an obstacle, forming thereby the lattice strain. The sintering atmosphere in this case is an atmospheric atmosphere so that a sufficient amount of oxygen can be supplied. Alternatively, to keep electrical neutrality, a part of Si, Al and Mg is emitted to form voids. Since the size of these defects is believed to be several angstroms or below, they cannot be measured as a specific surface area by an ordinary measuring method of the specific surface area such as a BET method using nitrogen molecules.

The number of the oxygen defects and that of the lattice defects have a correlation with the oxygen amount contained in cordierite. To support the necessary amount of the catalyst components described above, the oxygen amount may well be less than 47 wt % (oxygen defect) or at least 48 wt % (lattice defect). When the oxygen amount becomes less than 47 wt % due to the formation of the oxygen defect, the oxygen number contained in the unit crystal lattice of cordierite becomes smaller than 17.2 and the lattice constant of the bₒ axis of the crystal axis of cordierite becomes smaller than 16.99. When the oxygen amount exceeds 48 wt % due to the formation of the lattice defect, the oxygen number contained in the unit crystal lattice of cordierite becomes greater than 17.6, and the lattice constant of the bₒ axis of the crystal axis of cordierite becomes greater or smaller than 16.99.

Next, the ceramic support having a large number of elements capable of supporting the catalyst on the surface of the substrate ceramic will be explained. In this case, the elements replacing the constituent elements of the ceramic, that is, the elements replacing Si, Al and Mg as the constituent elements other than oxygen in the case of cordierite, preferably have higher bonding strength with the catalyst components to be supported than these constituent elements and can preferably support the catalyst components through the chemical bonds. Preferred examples of such replacing elements are those that are different from these constituent elements and have a d or f orbit in their electron orbit, preferably a vacant orbit in the d or f orbit, or two or more oxygen states. The elements having the vacant orbit in the d or f orbit have an energy level approximate to that of the catalyst components supported. As the exchange of the electrons is readily made, the elements are likely to be bonded with the catalyst components. The elements having two oxygen states, too, provide a similar function because the exchange of the electrons is readily made.

Concrete examples of the elements having the vacant orbit in the d or f orbit include W, Ti, V, Cr, Mn, Fe, Co, Ni, Zr, Mo, Ru, Rh, Ce, Ir and Pt. At least one kind of these elements can be used. Among these elements, W, Ti, V, Cr, Mn, Fe, Co, Mo, Ru, Rh, Ce, Ir and Pt are the elements that have two or more oxygen states.

When the constituent elements of the ceramic are replaced by use of these replacing elements, it is possible to employ a method that adds and kneads the starting material of the replacing element to the ceramic starting material in which a part of the materials of the constituent elements to be replaced is reduced in advance in accordance with the replacing amount. The material is shaped into a honeycomb shape, for example, is dried, and is then degreased and sintered in the atmosphere in accordance with an ordinary method. The thickness of the cell walls of the ceramic support is generally 150 μm or below. Because the thermal capacity becomes smaller when the wall thickness becomes smaller, the cell thickness is preferably small. Alternatively, it is also possible to employ a method that reduces a part of the starting material of the constituent elements to be replaced in accordance with the replacing amount, conducts kneading, shaping and drying in a customary manner and then lets the resulting molding be impregnated with a solution containing the replacing elements. After the product is taken out from the solution, it is similarly dried and is degreased and sintered in the atmosphere. When the method of causing the molding to be impregnated with the solution is employed, a large number of replacing elements are allowed to exist on the surface of the molding. In consequence, element substitution occurs on the surface during sintering and a solid solution is likely to develop.

The amount of the replacing elements is such that the total replacing amount is from at least 0.01% to 50% or below of the atomic number of the constituent elements to be replaced and preferably within the range of 5 to 20%. When the replacing element has different valence from that of the constituent element of the ceramic, the lattice defect or the oxygen defect simultaneously occurs in accordance with the difference of valence. However, these defects do not occur when a plurality of kinds of replacing elements is used and the amount is adjusted so that the sum of the oxidation numbers of the replacing elements is equal to the sum of the oxidation numbers of the constituent elements replaced. When the amount is adjusted in this way so that the change of valence does not occur as a whole, the catalyst components can be supported thorough only bonding with the replacing elements.

When the ceramic support, in which a part of the substrate ceramic is replaced by the element having high bonding strength with the catalyst component, is used, the catalyst components can be directly supported without the coating layer, and bonding with the ceramic can be advantageously increased.

The second feature of the invention is that either one of the main catalyst component and the sub catalyst component is supported on the ceramic support when the precious metal catalyst as the catalyst component and the sub catalyst are directly supported on the ceramic support described above, and the other is then supported on the former. When this supporting sequence is appropriately set, required performance can be improved. In the first embodiment shown in FIG. 1, for example, the precious metal catalyst as the main catalyst is supported and sintered, and the sub catalyst is then supported and sintered on the precious metal catalyst so as to position the main catalyst component to the lower layer when the precious metal catalyst and the sub catalyst are directly supported. This construction can suppress aggregation of the main catalyst due to thermal deactivation.

In this embodiment, as the main catalyst is first supported, a greater amount of the main catalyst can be directly supported and firmly bonded on and to the substrate ceramic of the ceramic support. Therefore, even when the particles of the sub catalyst disposed on the main catalyst grow due to thermal deactivation, the main catalyst firmly bonded to the substrate ceramic cannot easily move. It is therefore possible to prevent the main catalyst from being involved with the crystal growth of the sub catalyst and from undergoing aggregation and deactivation. Particularly when the direct support ceramic support into which the replacing element is introduced is used, bonding becomes stronger. Since exhaust gas purification takes place on the surface of the main catalyst, the surface area of the main catalyst, that is, the main catalyst, greatly contributes to purification performance. When thermal deactivation of the main catalyst is suppressed and the grain growth is slightly limited, the effect of suppressing the drop of purification performance is high. To obtain this effect, at least 75% of the catalyst components directly supported on the ceramic support is preferably the main catalyst component.

The precious metal catalyst such as Pt, Rh and Pd is generally and preferably used as the main catalyst component. However, the main catalyst is not particularly limited to the precious metal catalyst but may use a base metal catalyst, as well. Examples of the sub catalysts include lanthanoids such as La and Ce, transition metal elements such as Sc, Y, Cr, Mn, Fe, Co, Ni, Cu, Zr, Nb, Mo, Tc and Ru, alkali metal elements such as Na, K, Rb, Cs and Fr, and alkaline earth metal elements such as Mg, Ca, Sr, Ba and Ra. One or more kinds of these metal elements or their oxides or composite oxides can be used in accordance with the intended application.

The mean particle diameter of the main catalyst component such as the catalyst precious metal is generally 100 nm or below. The smaller the mean particle diameter, the smaller becomes the catalyst support amount to obtain desired catalyst performance. The mean particle diameter is preferably 50 nm or below. The sub catalyst component consisting of the metal oxide, etc, has a greater mean particle diameter than that of the catalyst precious metal, and is generally 100 nm or below, preferably 50 nm or below. To support the catalyst component, a solution containing each catalyst component is first prepared. The ceramic support is then impregnated with the solution, and is dried and sintered as in a customary method. The sintering temperature is generally from 100 to 1,000° C. The support amounts of the main catalyst component such as the catalyst precious metal and the sub catalyst component and their ratio may be set appropriately in accordance with required catalyst performance.

In the second embodiment shown in FIG. 2, when the precious metal catalyst and the sub catalyst are directly supported on the ceramic support described above, the sub catalyst is first supported and sintered and then the precious metal is supported and sintered. In this way, the purification performance can be improved, and the initial performance can be greatly improved, in particular. If the main catalyst exists as the lower layer of the sub catalyst or is mixed with the latter, there is the possibility that the sub catalyst may impede diffusion of the exhaust gas into the main catalyst. It is therefore effective in such a case to arrange the main catalyst layer on the surface layer and to improve the contact probability with the exhaust gas. As the reaction occurring on the surface of the main catalyst can thus be promoted, purification performance can be improved from the initial stage of the reaction. To obtain this effect, the sub catalyst component preferably occupies at least 75% of the catalyst components directly supported on the ceramic support.

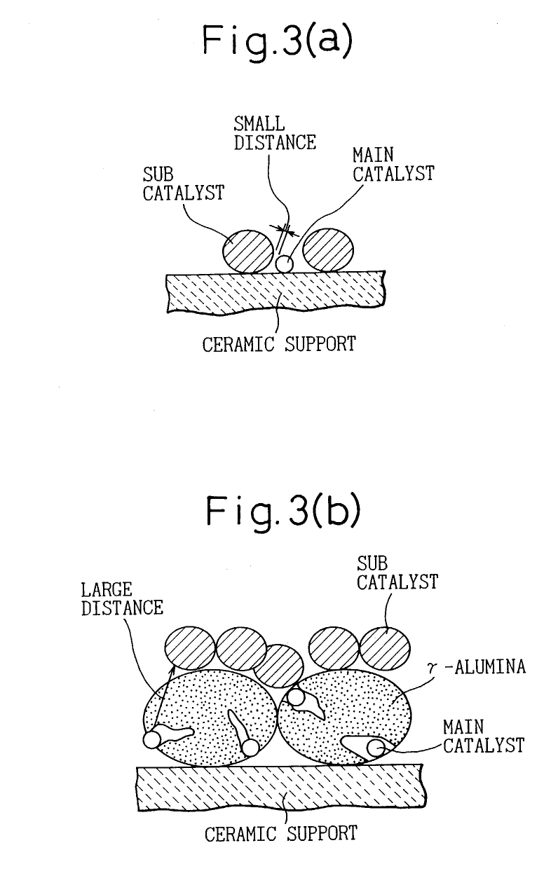

The improvement of performance resulting from the supporting sequence in this invention cannot be observed in the prior art construction in which the γ-alumina layer is formed. This is because the sub catalyst exists in the proximity of the main catalyst and exhibits the function as the sub catalyst. In the construction according to the invention, the distance between the main catalyst and the sub catalyst hardly changes even when the supporting sequence of the main catalyst and the sub catalyst is changed as shown in FIG. 3(a). In other words, because the distance between the main catalyst and the sub catalyst is small in the invention, both main and sub catalysts can sufficiently exhibit their respective functions. In contrast, in the prior art construction having the γ-alumina layer, the distance between the main catalyst and the sub catalyst becomes great as shown in FIG. 3(b) unless they are supported under the same condition as the simultaneous supporting condition of the invention. Therefore, the sub catalyst fails to exhibit its original performance and the effect is small.

### EXAMPLES 1 & 2

A ceramic catalyst body having the construction shown in FIG. 1 was produced by use of the following method and its effect was confirmed. First, talc, kaolin, alumina and aluminum hydroxide as the cordierite materials, WO₃ corresponding to 15% of Si as the constituent element and CoO similarly corresponding to 5% of Si element were prepared in such a fashion that the resulting composition was approximate to a theoretical composition point of cordierite. After suitable amounts of a binder, a lubricant, a humidity-keeping agent and moisture were added to the starting materials, the mixture was kneaded to convert them to clay. The resulting clay was shaped into a honeycomb shape having a cell wall thickness of 100 μm, a cell density of 400 cpsi and a diameter of 50 mm. After being dried, the honeycomb structure was sintered at 1,390° C. in an atmospheric atmosphere to obtain a ceramic support capable of directly supporting the catalyst components on the replacing elements (W, Co).

To first support Pt and Rh as the main catalyst components on the ceramic support so obtained, an ethanol solution dissolving 0.035 mol/L of platinic chloride and 0.025 mol/L of rhodium chloride was prepared. The ceramic support was immersed in this solution for 5 minutes. After an excessive solution is removed, the ceramic support was dried and is then sintered at 600° C. in the atmospheric atmosphere to metallize Pt and Rh. Next, to support the sub catalyst component, 400 g of CeO₂ powder and 4 g of alumina sol as an inorganic binder were dissolved in 1 L of water to form slurry. The ceramic support was immersed in this slurry. After the excessive slurry was removed, the ceramic support was dried and is then sintered at 900° C. in the atmosphere to give a ceramic catalyst body (Example 1). When the catalyst supporting condition of the resulting ceramic support was analyzed by an XAFS method, it was found that 85% of the catalyst component directly supported by the replacing elements (W, Co) was Pt or Rh.

A ceramic support capable of directly supporting catalyst components in fine pores consisting of the lattice defects was produced by using a similar cordierite material and replacing 5% of Mg as a constituent element by Ge. A main catalyst component and an sub catalyst component were similarly supported by the method described above to give a ceramic catalyst body (Example 2).

To evaluate purification performance of the ceramic catalyst bodies of Examples 1 and 2, a model gas containing C₃H₆ was introduced and a 50% purification temperature of C₃H₆ was measured. The evaluation condition is listed below. The 50% purification temperature was examined in the initial stage and after a thermal durability test (1,000° C. for 24 hours in the atmosphere), respectively.

Model gas:

| | |
|---|---|
| C₃H₆: | 500 ppm |
| O₂: | 5% |
| N₂: | balance |

SV = 10,000

As a result, it was found that the 50% purification temperature was 220° C. in the initial stage and 310° C. after the thermal durability test in Example 1. The 50% purification temperature in Example 2 was 220° C. in the initial stage and was the same as that of Example 1 but was as high as 356° C. and was higher by 46° C. after the thermal durability test. This is presumably because the bonding strength between the replacing element and the catalyst component in Example 1 was higher than the bonding strength between the fine pores consisting of the lattice defects and the catalyst component in Example 2 and the effect of suppressing the grain growth of the catalyst component due to thermal durability was greater.

The construction of this embodiment is particularly effective for obtaining a catalyst body for which high resistance is required because it is exposed to a high temperature, such as a start catalyst for a gasoline engine.

### EXAMPLES 3 & 4

A ceramic catalyst body was produced by use of the following method. First, talc, kaolin, alumina and aluminum hydroxide as the cordierite materials, WO₃ corresponding to 5% of Si as the constituent element and CoO similarly corresponding to 5% of Si element were prepared in such a fashion that the resulting composition is approximate to a theoretical composition point of cordierite. After suitable amounts of a binder, a lubricant, a humidity-keeping agent and moisture were added to the starting materials, and the mixture was kneaded to convert it to clay. The resulting clay was shaped into a honeycomb shape having a cell wall thickness of 100 μm, a cell density of 400 cpsi and a diameter of 50 mm. After dried, the honeycomb structure was sintered at 1,390° C. in an atmospheric atmosphere to obtain a ceramic support capable of directly supporting the catalyst components on the replacing elements (W, Co).

To first support the sub catalyst components on the ceramic support so obtained, 400 g of CeO₂ powder and 4 g of alumina sol as an inorganic binder were dissolved in 1 L of water to form slurry. The ceramic support was immersed in this slurry for one minute. After the excessive slurry was removed, the ceramic support was dried and was then sintered at 900° C. in the atmospheric atmosphere. Next, to support Pt and Rh as the main catalyst components, an ethanol solution dissolving 0.035 mol/L of platinic chloride and 0.025 mol/L of rhodium chloride was prepared. The ceramic support was immersed in this solution for 5 minutes. After an excessive solution is removed, the ceramic support was dried and was then sintered at 600° C. in the atmosphere to metallize Pt and Rh (Example 3). When the catalyst supporting condition of the resulting ceramic support was analyzed by the XAFS method, it was found that 80% of the catalyst component directly supported by the replacing elements (W, Co) is CeO₂.

A ceramic support capable of directly supporting catalyst components in fine pores consisting of the lattice defects was produced by using a similar cordierite material and replacing 5% of Mg as a constituent element by Ge. A main catalyst component and an sub catalyst component were similarly supported by the method described above to give a ceramic catalyst body (Example 4).

To evaluate purification performance of the ceramic catalyst bodies of Examples 3 and 4, a 50% purification temperature of C₃H₆ was measured in the same way as in Example 1. The 50% purification temperature was 195° C. in the initial stage and was 345° C. after a thermal durability test in Example 3. The 50% purification temperature in the initial stage became lower than that of Example 1. It can thus be appreciated that purification performance in the initial stage can be improved as the main catalyst component exists on the surface layer. The 50% purification temperature in the initial stage was 198° C. in Example 4 and was equivalent to that of Example 1. However, the 50% purification temperature after the thermal durability test was 373° C. and was higher by 28° C. than that of Example 1. This is because the bonding strength between the replacing element and the catalyst component in Example 3 is higher than the bonding strength between the fine pores consisting of the lattice defects and the catalyst component in Example 4 and the grain growth of the catalyst component due to thermal durability can be effectively suppressed.

### COMPARATIVE EXAMPLE 1

First, talc, kaolin, alumina and aluminum hydroxide as the cordierite materials were prepared in such a fashion that the resulting composition is approximate to a theoretical composition point of cordierite. After suitable amounts of a binder, a lubricant, a humidity-keeping agent and moisture were added to the starting materials, the mixture was kneaded to convert it to clay. The resulting clay was shaped into a honeycomb shape having a cell wall thickness of 100 μm, a cell density of 400 cpsi and a diameter of 50 mm. After dried, the honeycomb structure was sintered at 1,390° C. in an atmospheric atmosphere to obtain a ceramic support.

The construction of this embodiment is particularly effective for obtaining a catalyst body which is not exposed to a relatively high temperature and for which high purification performance is required, such as an under-floor catalyst for a gasoline engine and an oxidation catalyst for a Diesel engine.

To support the main catalyst and the sub catalyst components on the ceramic support so obtained, 0.035 mol/L of titanic chloride, 0.025 mol/L of rhodium chloride, 400 g of CeO₂ powder and 4 g of alumina sol as an inorganic binder were dissolved to form slurry. The ceramic support was immersed in this slurry for five minutes. After the excessive slurry was removed, the ceramic support was dried and was then sintered at 600° C. in the atmosphere to give a comparative ceramic catalyst body (Comparative Example 1). When the catalyst supporting condition of the resulting ceramic support was analyzed by the XAFS method, it was not found that the constituent elements (Si, Al, Mg) of the ceramic catalyst body are directly bonded to CeO₂.

To evaluate purification performance of the ceramic catalyst bodies of Comparative Example 1, a 50% purification temperature of C₃H₆ was measured in the same way as in Example 1. The 50% purification temperature in Comparative Example 1 was 205° C. in the initial stage and initial purification performance became lower than that in Examples 3 and 4. The 50% purification temperature after the thermal durability test was 397° C., and it can be understood that thermal durability greatly drops in comparison with Examples 1 to 4 when a coating layer of γ-alumina is formed.

As described above, it is possible to provide a catalyst body having high heat resistance and effectively improving purification performance by using a ceramic support capable of directly supporting catalyst components without a coating layer and by changing a supporting sequence of a main catalyst component and an sub catalyst component in accordance with the intended object. Particularly when a ceramic support containing a replacing element, that has high bonding strength with the catalyst component and is introduced into the ceramic support, is used, a catalyst body which has highly improved purification performance and thermal durability can be provided.

What is claimed is:

1. A ceramic catalyst body using a ceramic support capable of directly supporting catalyst components on a surface of a substrate ceramic and prepared by directly supporting a main catalyst component and an sub catalyst component on said ceramic support, wherein either one of said main catalyst component and said sub catalyst component is first supported on said ceramic support and the other is then supported.

2. A ceramic catalyst body according to claim 1, wherein at least 75% of said catalyst components directly supported on said ceramic support is said main catalyst component.

3. A ceramic catalyst body according to claim 2, which is used as a start catalyst fitted to an automobile having a gasoline engine mounted thereto.

4. A ceramic catalyst body according to claim 1, wherein at least 75% of said catalyst components directly supported on said ceramic support is said sub catalyst component.

5. A ceramic catalyst body according to claim 4, which is used as an under-floor catalyst fitted to an automobile having a gasoline engine mounted thereto or as an oxidation catalyst fitted to an automobile having a Diesel engine mounted thereto.

6. A ceramic catalyst body according to claim 1, wherein said main catalyst component contains a precious metal catalyst.

7. A ceramic catalyst body according to claim 1, wherein a mean particle diameter of said main catalyst component is not greater than 100 nm.

8. A ceramic catalyst body according to claim 1, wherein a mean particle diameter of said sub catalyst component is not greater than 100 nm.

9. A ceramic catalyst body according to claim 1, wherein said ceramic support has a large number of fine pores capable of directly supporting a catalyst on the surface of said substrate ceramic, and said fine pores can directly support said catalyst components.

10. A ceramic catalyst body according to claim 9, wherein said fine pore is at least one kind of defect inside a ceramic crystal lattice, a fine crack on a ceramic surface and a defect of elements constituting the ceramic.

11. A ceramic catalyst body according to claim 10, wherein a width of said fine crack is not greater than 100 nm.

12. A ceramic catalyst body according to claim 10, wherein said fine pore has a diameter or width not greater than 1,000 times the diameter of a catalyst ion to be supported, and the number of said fine pores is at least 1×10¹¹/L.

13. A ceramic catalyst body according to claim 1, wherein one or more kinds of elements constituting said substrate ceramic of said ceramic support are replaced by elements other than said constituent elements, and said catalyst component can be directly supported by said replacing elements.

14. A ceramic catalyst body according to claim 13, wherein said catalyst component is supported on said replacing elements through chemical bonds.

15. A ceramic catalyst body according to claim 13, wherein said replacing elements are one or more kinds of elements having a d or f orbit in an electron orbit thereof.

16. A ceramic catalyst body according to claim 1, wherein said substrate ceramic contains cordierite as a component thereof.
